(19) United States
(12) Patent Application Publication
(10) Pub. No.: US 2020/0020031 A1
(43) Pub. Date: Jan. 16, 2020

(54) SYSTEMS AND METHODS FOR EVALUATING AND PRICING MUNICIPAL BOND OFFERINGS

(71) Applicant: Lumesis, Inc., Stamford, CT (US)

(72) Inventor: Gregg L. Bienstock, Stamford, CT (US)

(73) Assignee: Lumesis, Inc., Stamford, CT (US)

(21) Appl. No.: 16/509,612

(22) Filed: Jul. 12, 2019

Related U.S. Application Data
(60) Provisional application No. 62/697,762, filed on Jul. 13, 2018.

(51) Int. Cl. G06Q 40/04; G06Q 30/02

(52) U.S. Cl. CPC G06Q 40/04; G06Q 30/0206

(57) ABSTRACT

This invention relates to systems and methods for aggregating, analyzing, searching, and reporting municipal bond market data and related information from disparate data sources.

### CROSS-REFERENCE TO RELATED APPLICATIONS

This application claims priority from and incorporates by reference in its entirety U.S. Provisional Patent Application Ser. No. 62/697,762 for “Systems and Methods for Evaluating and Pricing Municipal Bond Offerings,” filed Jul. 13, 2018.

### FIELD OF THE INVENTION

This application relates to systems for systems and methods for aggregating, analyzing, searching, and reporting municipal bond market data and related information from disparate data sources.

### BACKGROUND OF THE INVENTION

Municipal securities, or “munis,” are bonds issued by states, cities, counties and other governmental entities, subdivisions, authorities and to raise money to build roads, schools and a host of other projects for the public good.

Municipal bonds may be purchased in the initial offering of the bonds, typically through municipal securities dealers that underwrite the bonds or assist the underwriters to distribute the newly issued bonds. This type of transaction may be referred to as a “primary market transaction” or a “new issue transaction,” in contrast to secondary market transactions that take place following the initial issuance.

In new issues, list offering prices are typically disclosed as the prices at which a substantial portion of the issue was offered to the public. Most primary market trades during the initial distribution of a new issue will occur at this list-offering price. Underwriters determine the coupon rates and prices that they will bid or negotiate for bonds by evaluating the new issue in terms of the market for if similar issues. To determine these prices, the underwriters use criteria such as credit quality, trading quality, maturity range, interest rate or yield, call features, tax status, market sector, scarcity/saturation of new issues and the overall levels of interest rates. Other market participants, such as municipal advisors, may use similar comparison information to challenge an underwriter's price.

Locating and evaluating similar issues and associated trades is difficult. There are over 1.1 million individual bonds outstanding and municipal issues come to market with varying maturities and other terms. Because municipal debt markets are comprised of a wide array of issuers and their respective debt instruments, which are often unique in terms of bond ratings, debt structures, and yields, the criteria for pricing a new issue or comparing a new issue to similar issues is not be the same in every situation and can be done differently by market participants. And the publicly-available data concerning the municipal bond market is not structured such that the entire market can be quickly searched to find comparable past issues having particular characteristics.

Thus, there is a need in the art for a system that allows a user o effectively and efficiently aggregate municipal bond market data and information from disparate data sources, search for comparable issues using relevant parameters to find deals with particular characteristics, analyze primary and secondary market observations (trades), and generate reports including graphical yield curves. It is to be appreciated that user 140 may include or exclude data concerning past issues and other yield curves customarily used in the market for comparison purposes, as desired, and the reports are automatically updated based upon user 140 selections.

### SUMMARY OF THE INVENTION

The present invention comprises, in one form thereof, a system for municipal market participants to aid in pricing new issue debt for deals and negotiations. The system eliminates e spent on extensive data gathering and permits customizable data parameters, reports and yield curves with underlying detail comprising the component parts (comparable issues and trades) of the yield curve.

In another embodiment, the invention disclosed here provides a system comprising: a memory; a computer processor disposed in communication with said memory, and configured to execute a plurality of instructions stored in the memory; a normalizing module configured and operable to aggregate, standardize, and label municipal bond market data from disparate data sources, a storage module configured and operable to store aggregated, standardized, and labeled municipal bond market data in memory; a search module configured and operable by a user to search aggregated, standardized, and labeled municipal bond market data for issues or transactions having at least one user-selected characteristic selected from the group consisting of prior number of days, sector, state, at series size, location, maturity profile callability, issue type, bank qualification, insurance, and tax status; a reporting module configured and operable by the user to generate search results containing at least two issues or transactions, each containing at least one search result datum selected from the group consisting of primary market yields, sale date, issuer, issue description, coupon, first call date, trade date, and yield; a display operable to display the search results to the user; a selection module configured and operable to add or eliminate at least one issue or transaction from the search results; and an observations module configured and operable to generate primary and secondary observations.

In another embodiment, the invention disclosed here provides a computer-implemented method comprising the steps of: aggregating, standardizing, and labeling municipal bond market data from disparate data sources, storing the aggregated, standardized, and labeled municipal bond market data in memory; providing a user interface to a user through a computer-facilitated platform through which aggregated, standardized, and labeled municipal bond market data is accessible by the user; searching the aggregated, standardized, and labeled municipal bond market data for issues or transactions having at least one user-selected characteristic selected from the group consisting of prior number of days, sector, state, rating, series size, location, maturity profile, callability, issue type, bank qualification, insurance, and tax status; generating search results containing at least two issues or transactions, each containing at least one search result datum selected from the group consisting of primary market yields, sale date, issuer, issue description, coupon, first call date, trade date, and yield; displaying the search results to the user; selecting, by the user, at least one issue or transaction from the search results to eliminate; eliminating the selected at least one issue or transaction the search results; and generating primary and secondary observations.

In yet another embodiment, the primary and secondary observations include a graphical yield curve based upon the search results, a target issue scale, and/or user input pricing yields.

### BRIEF DESCRIPTION OF THE DRAWINGS

The invention is disclosed with reference to the accompanying drawings, wherein:

FIG. 1 is a schematic illustration of a communications network within which an embodiment of the invention may operate;

FIGS. 2A and 2B illustrate exemplary user screens from one embodiment of the system of the invention;

FIG. 3 illustrates an exemplary search results screen from one embodiment of the system of the invention following a user-executed search for prior issues or deals and relevant trades;

FIG. 4A-4C illustrate exemplary screens from one embodiment of the system of the invention where a user can eliminate individual issues or transactions, as appropriate or desired; and

FIG. 5 illustrates an exemplary screen from one embodiment of the system of the invention including generated system-generated graphical representations and curves.

Corresponding reference characters indicate corresponding parts throughout the several views. The examples set out herein illustrate several embodiments of the invention but should not be construed as limiting the scope of the invention in any manner.

### DETAILED DESCRIPTION

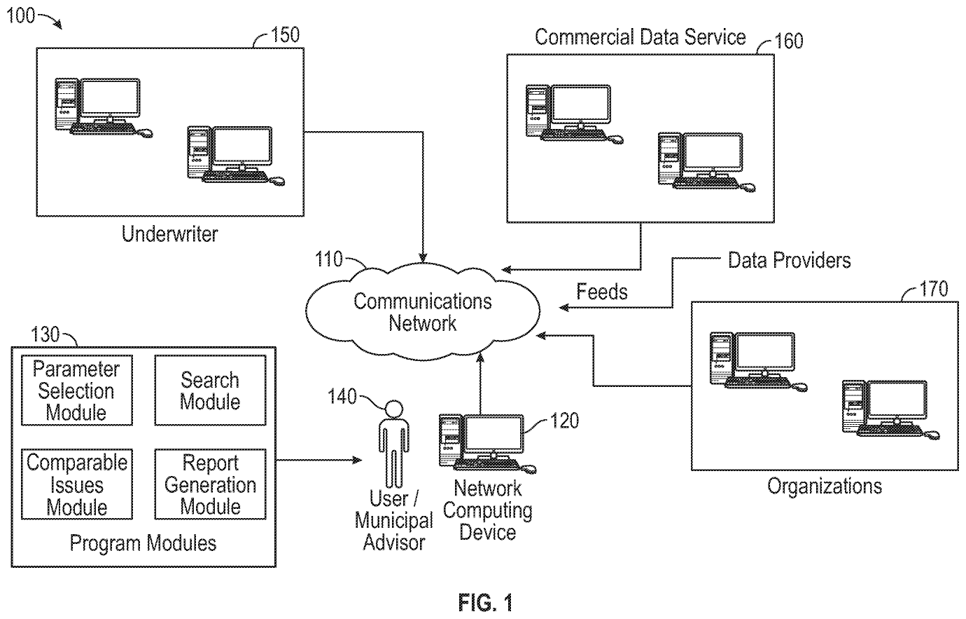

Turning now to FIG. 1, an embodiment of a system 100 is shown and includes a communications network 110 in which the below illustrated embodiments may be implemented. The communication network is a geographically distributed collection of nodes interconnected by communication links and segments for transporting data between end nodes, such as personal computers, work stations, smart phone devices, tablets, televisions and or other devices such as automobiles, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others.

The communication network illustratively comprises nodes/devices (e.g., sensors, client computing devices, smart phone devices, web servers, routers, switches, and the like) interconnected by various methods of communication. For instance, the links may be wired links or may comprise a wireless communication medium, where certain nodes are in communication with other nodes, e.g., based on distance, signal strength, current operational status, location, etc. Moreover, each of the devices can communicate data packets (or frames) with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited, and may be applied to networks that are hardwired.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to illustrations according to embodiments of the invention. It will be understood that each illustration can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including which implement the function/act specified in the illustrations.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the illustrations.

In one form, the invention comprises a network computing device 120 (e.g., client computing device, server, etc.) that may be used (or components thereof) with one or more embodiments described herein, e.g., as one of the nodes in the network. As explained above, in different embodiments these various devices are configured to communicate with each other in any suitable way, such as, for example, via the communication network.

The network computing device 120 is intended to represent any type of computer system capable of carrying out the teachings of various embodiments of the present invention. The network computing device 120 is only one example of a suitable system and is not intended to suggest any limitation as to the scope of use or functionality of embodiments of the invention described herein. Regardless, the network computing device 120 is capable of being implemented and/or performing any of the functionality set forth herein.

The network computing device 120 is operational with numerous other general purpose or special purpose computing system environments or configurations. Examples of well-known computing systems, environments and/or configurations that may be suitable for use with computing device include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, and distributed data processing environments that include any of the above systems or devices, and the like.

The network computing device 120 may be described in the general context of computer system-executable instructions, such as program modules, being executed by a computer system. Generally, program modules may include routines, programs, objects, components, logic, data structures, and so on that perform particular tasks or implement particular abstract data types. The network computing device 120 may be practiced in distributed data processing environments where tasks are performed by remote processing devices that are linked through a communications network. In a distributed data processing environment, program modules may be located in both local and remote computer system storage media including memory storage devices.

The components of the network computing device 120 may include, but are not limited to, one or more processors or processing units, a system memory, and a bus that couples various system components including system memory to processor.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The network computing device 120 typically includes a variety of computer system readable media. Such media may be any available media that is accessible by the device, and it includes both volatile and non-volatile media, removable and non-removable media.

System memory can include computer system readable media in the form of volatile memory, such as random access memory (RAM) and/or cache memory. Computing device may further include other removable/non-removable, volatile/non-volatile computer system storage media. By way of example only, a storage system can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to a bus by one or more data media interfaces. A memory may include at least one program product having a set (e.g., at least one) of program modules that are configured to carry out the functions of embodiments of the invention.

Within the exemplary network computing device 120, certain illustrated embodiments of the present invention will now be provided, which is to be implemented on network computing device 120 in communications network 110. The system 100 further includes a program/utility, having a set (at least one) of program modules 130, such as parameter selection module, search module, comparable issues module, report generation module, which may be stored in memory by way of example, and not limitation, as well as an operating system, one or more application programs, other program modules, and program data. Each of the operating system, one or more application programs, other program modules, and program data or some combination thereof, may include an implementation of a networking environment. Program modules 130 generally carry out the functions and/or methodologies of embodiments of the invention as described herein.

The network computing device 120 may also communicate with one or more external devices such as a keyboard, a pointing device, a display, etc.; one or more devices that enable a user to interact with computing device; and/or any devices (e.g., network card, modem, etc.) that enable the computing device to communicate with one or more other computing devices. Such communication can occur via Input/Output (I/O) interfaces. Still yet, the computing device can communicate with one or more networks such as a local area network (LAN), a general wide area network (WAN), and/or a public network (e.g., the Internet) via network adapter. A network adapter may communicate with the other components of the computing device via bus. It should be understood that although not shown, other hardware and/or software components could be used in conjunction with device. Examples, include, but are not limited to: microcode, device drivers, redundant processing units, external disk drive arrays, RAID systems, tape drives, and data archival storage systems, etc.

In an exemplary use case, a user 140, such as a municipal advisor, accesses the system of the invention in order to locate and evaluate comparable issues to set the price for a new issue, or identify the best structure for a particular transaction it is bringing to market for an issuer of debt. Alternatively, the user 140 may wish to challenge an underwriter's 150 price using data from comparable issues in the same sector.

In another exemplary use case, an underwriter 150 accesses the system 100 in order to support proposed market pricing in a negotiated transaction or for bid on a competitive transaction coming to market.

With regards to the one or more illustrated embodiments of the present invention, it is to be understood a platform executing on the network computing device 120 may be web- or cloud-based and accessed via user name and password. After successful logging-in, user 140 is presented with a screen depicting exemplary parameters such as, but not limited to, sector, deal size, location, maturity profile, callability, issue type, tax status that may be input or selected by user 140 to build a search for comparable issues and trades.

The data concerning the prior issues may be obtained, ingested, analyzed, searched, and stored by the system over a communications network from one or more publicly-available data feeds. Such feeds continually monitor a wide range of official and other respected data sources concerning municipal bond transactions, compiling volumes of information and cataloging it into organized relational database formats. Feeds may be, available from commercial sources 160 such as Mergent, Ipreo, rating agencies and organizations 170 such as, but t limited to, the Municipal Securities Rulemaking Board and the CUSIP Service Bureau.

The system of the present invention may access data sources concerning municipal bond transactions, and organize and label it according to desired parameters. For example, the system of the present invention identifies and tags certain transactions based upon sector. Because the data is derived from multiple data sources, not all transactions will be identified in the same way by each source. The system creates a standardized sector designation for every transaction, e.g., “Utilities Water New York City.” Additionally, the system identifies and tags each transaction to a standardized obligor from an obligor database. Furthermore, data sources may identify the same issuer differently in the feeds, e.g., as “New York City” or “New York, New York” or “City of New York”. The system recognizes and standardizes and structures the incoming data feeds so that each transaction is identifiable with an assigned sector and obligor name. Without this “normalization” or structuring process undertaken prior to searching for and evaluating comparable issues, relevant transactions may be missed by user 140 or inadvertently excluded from search results. The normalized or structured data ingested from the data feeds may be organized and stored in memory by the system and made accessible to a search module for queries.

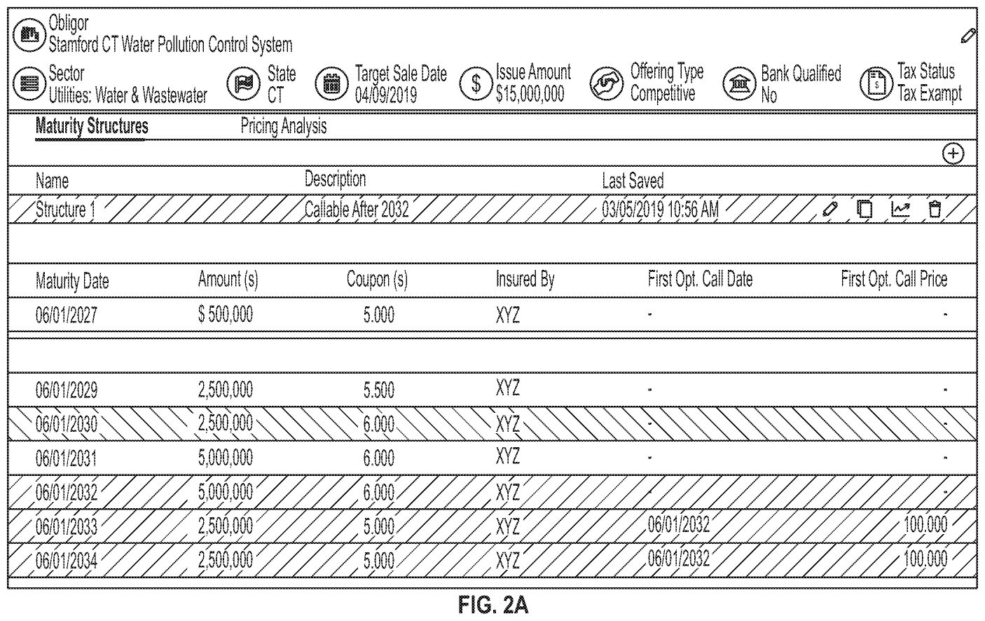

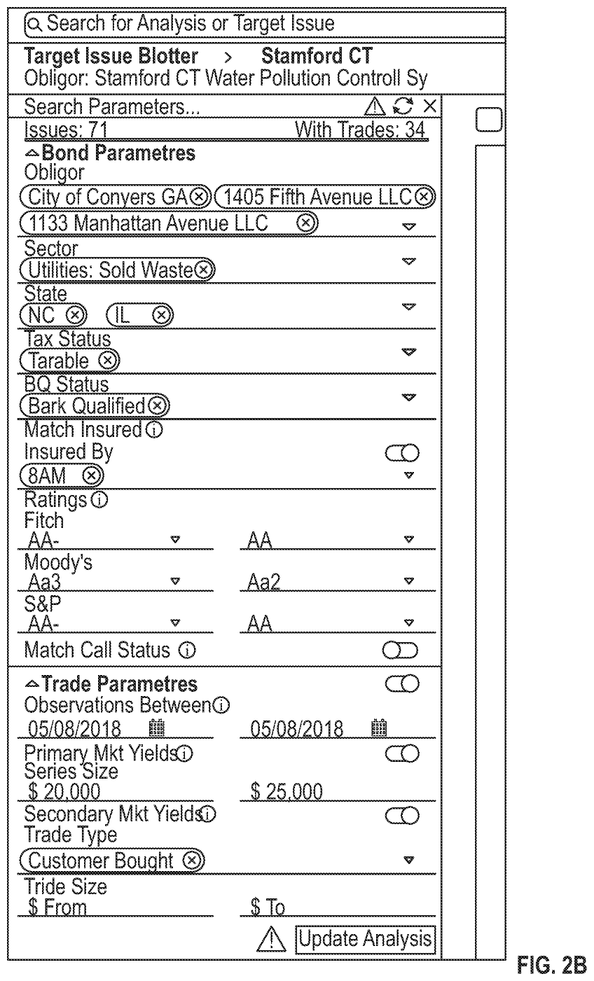

In connection with the search functionality of the present invention, user 140 may select or input one or parameters via a user interface, which may include but not be limited to, by way of example only:
Prior Number of Days. The number of days to search for comparable new issue debt and both primary and secondary trades of the same. A user may input a particular number for this parameter.
Sector(s). User 140 may select from a set of sector identifiers. As discussed above, the system of the invention identifies and labels each municipal obligor and issue in a database with a unique sector identifier and normalized obligor identity or name. The sector identifier can be one off over 20 sectors.
State(s). User 140 may select one, several or all U.S. states to differentiate between or narrow down a set of comparable deals by location
Moodys, S&P and Fitch. User 140 may select a minimum, range, or specific rating by one or more ratings provided by rating agencies Moody's, Fitch and S&P. Ratings information may be obtained by the system from data feeds from the rating agencies.
Series Size. User 140 may select a range for the size of the issue, which is derived from data feeds available from providers such as Ipreo, Mergent and/or CUSIP Bureau.
Callable. User 140 may select if the bonds are callable, which is derived from data feeds available from providers such as Ipreo, Mergent and/or CUSIP Bureau.
Tax Status. User 140 may select the tax status of the issue, including whether it is tax exempt, taxable, or subject to the AMT, which is derived from data feeds available from providers such as Ipreo, Mergent and/or CUSIP Bureau.
Bank Qualified. User 140 may select whether the bonds are bank qualified or not, which is derived from data feeds available from providers such as Ipreo, Mergent and/or CUSIP Bureau.
Insured. User 140 may select whether the bonds are insured, which is derived from data feeds available from providers such as Ipreo, Mergent and/or CUSIP Bureau.
Maturity Tolerance. User 140 may input a range of dates (forward and back) from the Maturity Date across the issue in order to search for comparable issues and trades.
Secondary Trades Within. User 140 may input a number of days from the “Date” to search for secondary market trades.
Maturity. User 140 may input a number of year(s) from the “Date” set by user 140.
Maturity Date. The actual maturity dates, derived from user 140 inputs.
Low/High Mat Date. The low and high maturity dates used to identify comparable bonds, based on the Maturity Date and Maturity Tolerance, which is derived from user 140 input. According to one embodiment, as shown in FIGS. 2A and 2B, a set of parameters is made available via a screen to user 140, who enters the relevant information (e.g., Prior Number of Days) or choses or selects the parameter (e.g., States) as shown in the exemplary options menu of FIG. 2B. User 140 o will be, also able to set maturity and call tolerances, etc.

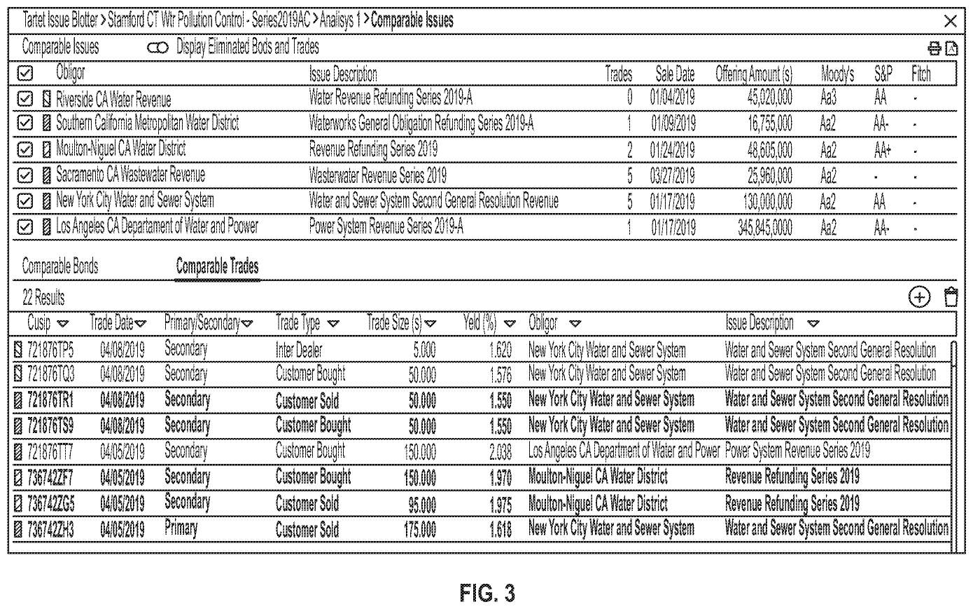

Once the desired parameters are entered and/or selected, user 140 may execute a search of the memory containing the query-able data feed database for prior issues or deals and relevant trades, primary and secondary (using, e.g., an “Execute Search” button), as illustrated in FIG. 3. System 100 will generate queries and search results containing bibliographic and additional data concerning the search results, as shown in FIG. 3, and present the results and data to user 140 via user interface 300. This additional data presented to user 140 may include but not be limited to:
Primary Market Yields—Low/Mid/High. For comparable bonds for the Maturity Date, this field identifies the low, high and mid-point yields, which is derived from data feeds available from providers such as Ipreo, Mergent and/or CUSIP Bureau.
Sale Date. The date the bond was sold, which is derived from data feeds available from providers such as Ipreo, Mergent and/or CUSIP Bureau.
Issuer. Named issuer of the bonds, which is derived from data feeds available from providers such as Ipreo, Mergent and/or CUSIP Bureau.
Issue Description. A description or title of the issue, which is derived from data feeds available from providers such as Ipreo, Mergent and/or CUSIP Bureau.
Coupon. The stated coupon for the security, which is derived from data feeds available from providers such as Ipreo, Mergent and/or CUSIP Bureau.
First Call Date. The date on which the security is first callable, which is derived from data feeds available frog providers such as Ipreo, Mergent and/or CUSIP Bureau.
Trade Date. The date the bond was traded, which is derived from data feeds available from providers such as Ipreo, Mergent and/or CUSIP Bureau.
Yield. The actual yield on the date of the trade, which is derived from data feeds available from providers such as Ipreo, Mergent and/or CUSIP Bureau.
   Other data fields may be made available, as shown or desirable to one of ordinary skill in the art.

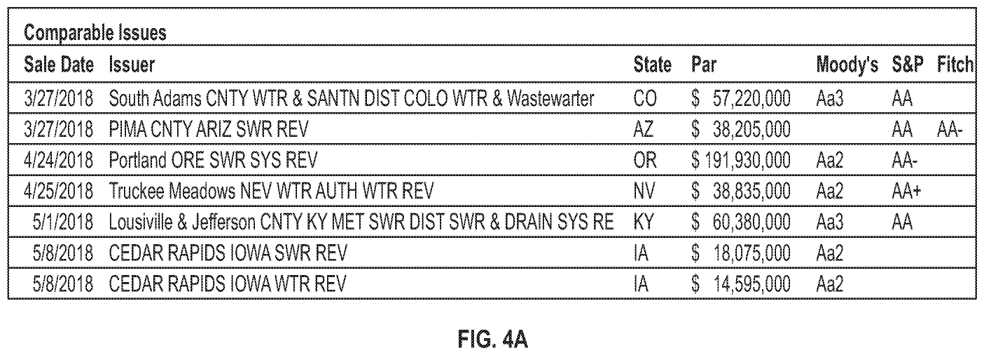

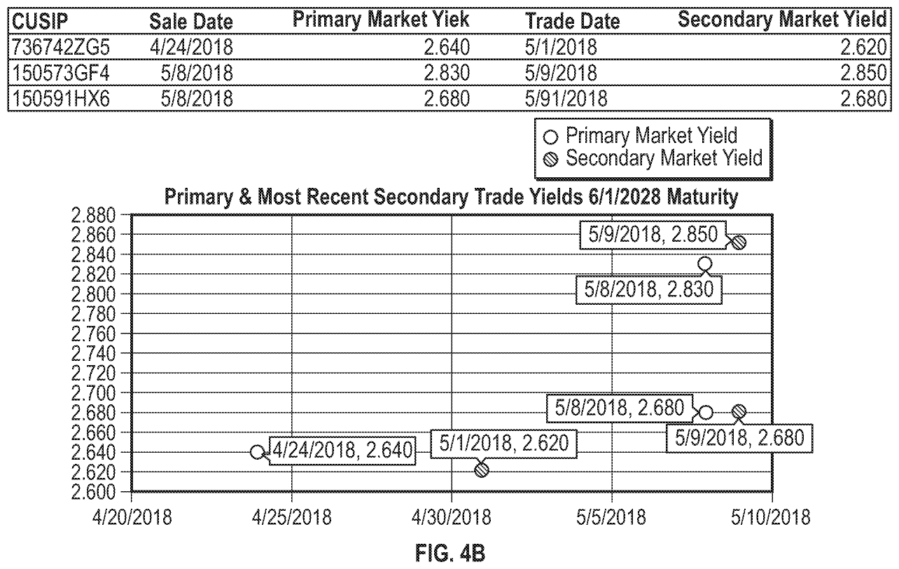

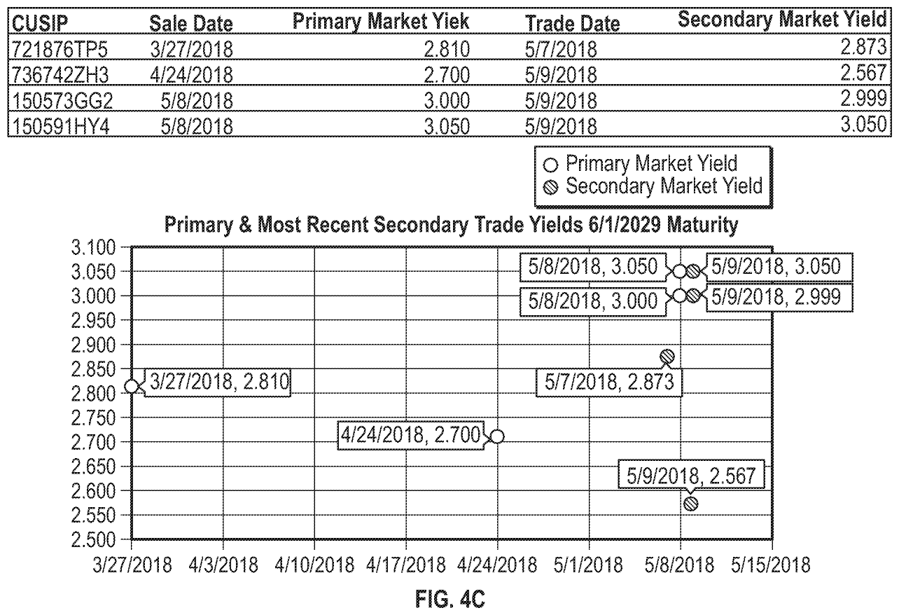

Upon being presented with the search results and additional data, user 140 can eliminate individual issues or transactions as appropriate or desired, as shown in FIGS. 4A, 4B, and 4C.

For example, if the data associated with a particular comparable issue or transaction presented in the search results is an “outlier,” or would skew or otherwise be irrelevant to the comparison being undertaken, user 140 may wish to exclude the issue from any reports (e.g., generated yield curves). In the example set forth in FIG. 4A, user 140 may wish to exclude Apr. 24, 2018 PORTLAND ORE SWR SYS REV, and its particularly high Par value of $ 191,930,000. To accomplish this, user 140 selects or de-selects the comparable issue for exclusion, and the system will automatically update any reports or graphical representations to exclude data concerning such excluded issue, such as illustrated in FIGS. 4B and 4C.

In addition to controlling comparable issue search parameters, and including or excluding individual issues, municipal securities issuers and investors may use the system to select parameters or indicators to assist in the evaluation of a unique bond's yield or its performance relative to a particular sector or the market as a whole. Indices, yield curves and benchmarks often are used as a factor when determining the yield levels at which a new issue of municipal securities will be/should be offered to investors. The system is operable to generate such reports via a report generation module.

A yield curve, for example, is a representation of different interest rates for bonds with different maturities. A yield curve may be a good indicator of market supply and demand of bonds with different maturities and is typically based on the yields of these bonds trading in the market or their yield estimates. In addition, since bond prices and bond yields are inversely correlated, there are different factors that impact both the short and long ends of the yield curve, contributing to the eventual shape of the curve. Yield curve and other benchmarks can effectively be used for evaluating bond prices and yields. This information is critical for issuers in their preparations for and during the bond pricing process and setting up baselines to establish yield levels for their new issuances and comparative bond pricings.

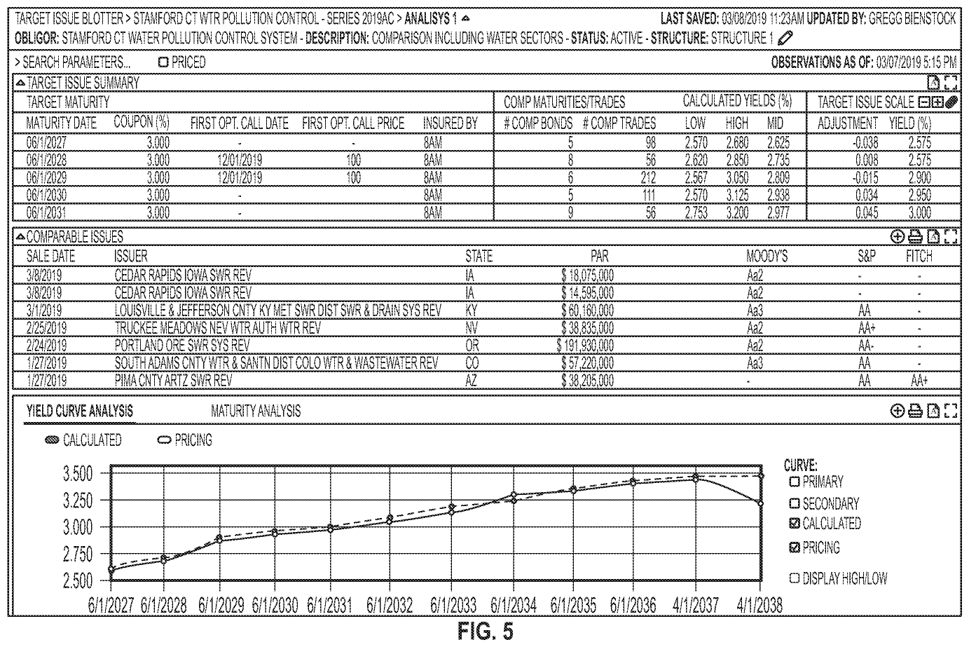

As in FIG. 5, along with the data concerning the comparable issues identified during the search function, the system is operable to generate primary and secondary observations as well as Target Issue Scale (or user input) data and related reports, including generated graphical representations and curves, such as calculated yield curves. The underlying data used to generate such primary and secondary market yield curves is shown to and/or accessible to user 140 (e.g., by “clicking-through” or hovering) for each maturity. The system may further provide the same representation for secondary trade observations, i.e., average secondary market trades.

Additional reporting functions are available. For example, the system's report generation module may be used to generate primary and secondary observations, calculated yields and user input pricing yields.

For each data point, user 140 may access, by clicking on the graphical representation, the underlying trades that provide the data used by the system to calculate each midpoint, and user 140 may select or de-select any outliers. The yield graph may then be automatically updated by the system.

The system further provides additional opportunities for user 140 to modify and/or refine the results based upon parameters and/or user 140's perspective in the market. As discussed above, user 140 may de-select or eliminate comparable issues, or add issues or deals that were not generated by the system with the original parameter search results.

Once user 140 completes any additions or de-selections from the underlying data, the system may be used to generate a set of component aspects of a particular hypothetical issue. These component aspects may be based upon a selected yield midpoint chosen by user 140, and presented to user 140 in the form of a list, table, or graph.

Additionally, user 140 may use the reporting function to add to any generated report or yield curve other yield curves available in the market. Such curves may include 10 and 30 year US Treasury, 10 and 30 Year Thomson Reuters Municipal Market Data, Bloomberg's evaluated pricing service, BVAL, amongst others.

The foregoing is intended to provide a brief, general description of an illustrative and/or suitable exemplary environment in which embodiments of the described present invention may he implemented. This is exemplary of a suitable environment and not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

The embodiments described below are merely exemplary, which can be embodied in various forms, as appreciated by one skilled in the art. Therefore, it is to be understood that any structural and functional details disclosed herein are not to be interpreted as limiting, but merely as a basis for the claims and as a representation teaching one skilled in the art to variously employ the discussed embodiments. Furthermore, the terms and phrases used herein are not intended to be limiting but rather to provide an understandable description of the illustrated embodiments.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the illustrated embodiments, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated that the embodiments discussed below are preferably a software algorithm, program or code residing computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the illustrated embodiments based on the above-described embodiments. Accordingly, the illustrated embodiments are not to be limited by what has been particularly shown and described, except as indicated by the appended claims.

We claim:

1. A system comprising:
a memory;
a computer processor disposed in communication with said memory, and configured to execute a plurality of instructions stored in the memory;
a normalizing module configured and operable to aggregate, standardize, and label municipal bond market data from disparate data sources,
a storage module configured and operable to store aggregated, standardized, and labeled municipal bond market data memory;
a search module configured and operable by a user to search aggregated, standardized, and labeled municipal bond market data for issues or transactions having at least one user-selected characteristic selected from the group consisting of prior number of days, sector, state, rating, series size, location, maturity profile, callability, issue bank qualification, insurance, and tax status;
a reporting module configured and operable by the user to generate search results containing at least two issues or transactions, each containing at least one search result datum selected front the group consisting of primary market yields, sale date, issuer, issue description, coupon, first call date, trade date, and yield;
a display operable to display the search results to the user;
a selection module configured and operable to add or eliminate at least one issue or transaction from the search results; and
an observations module configured and operable to generate primary and secondary observations.

2. A computer-implemented method comprising the steps of:
aggregating, standardizing, and labeling municipal bond market data from disparate data sources,
storing the aggregated, standardized, and labeled municipal bond market data in memory;
providing a user interface to a user through a computer-facilitated platform through which aggregated, standardized, and labeled municipal bond market data is accessible by the user;
searching the aggregated, standardized, and labeled municipal bond market data for issues or transactions having at least one user-selected characteristic selected from the group consisting of prior number of days, sector, state, rating, series size, location, maturity profile, callability, issue type, bank qualification, insurance, and tax status;
generating search results containing at least two issues or transactions, each containing at least one search result datum selected from the group consisting of primary market yields, sale date, issuer, issue description, coupon, first call date, trade date, and yield;
displaying the search results to the user;
selecting, by the user, at least one issue or transaction from the search results to eliminate;
eliminating the selected at least one issue or transaction from the search results;
and generating primary and secondary observations.

3. The method of claim 2 wherein the primary and secondary observations include a graphical yield curve based upon the search results.

4. The method of claim 2 wherein the primary and secondary observations include a target issue scale.

5. The method of claim 2 wherein the primary and secondary observations include user input pricing yields.
